(19) United States
(12) Patent Application Publication
(10) Pub. No.: US 2010/0118047 A1
(43) Pub. Date: May 13, 2010

(54) MULTISPECTRAL IMAGE PROCESSING DEVICE AND COLOR REPRODUCTION SYSTEM USING THE SAME

(75) Inventors: Takeyuki Ajito, Tokyo (JP); Yasuhiro Komiya, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/631,185

(22) Filed: Dec. 4, 2009

Related U.S. Application Data
(63) Continuation of application No. PCT/JP2008/059827, filed on May 28, 2008.

(30) Foreign Application Priority Data
Jun. 4, 2007 (JP) 2007-148397

(51) Int. Cl. G09G 5/02

(52) U.S. Cl. 345/589

(57) ABSTRACT

A multispectral image processing device of the present invention comprising: a base image conversion unit 6, which expands an input multiband image of a subject based on a base vector to convert it into a base image; a base vector calculation unit 2, which calculates the base vector; and an output unit 7, which outputs a multispectral image based on the base image converted in the base image conversion unit 6 is characterized in that the base vector calculation unit 2 calculates a base vector for 3 primary colors obtained by the product of a predetermined rendering illumination spectrum and a color matching function, and an orthogonal base vector, which is orthogonal to the base vector for 3 primary colors and based on statistical information on the spectral reflectance of the subject as the base vectors. Thereby, a multispectral image is converted into image data highly compatible with an existing 3-band system.

### CROSS REFERENCE TO RELATED APPLICATION

The present application is a Continuing Application based on International Application PCT/JP2008/059827 filed on May 28, 2008, which, in turn, claims the priority from Japanese Patent Application No. 2007-148397 filed on Jun. 4, 2007, the entire disclosure of these earlier applications being herein incorporated by reference.

### BACKGROUND OF INVENTION

1. Field of the Invention

The present invention relates to a multispectral image processing device for converting a multiband image having spectral sensitivity characteristics of not less than 3 bands obtained by a multispectral camera and the like into image data for remote transmission or recording in a recording medium, particularly to a multispectral image processing device, which maintains compatibility with an existing 3 primary color device and further converts an image into image data capable of dealing with high-accuracy illumination conversion on the observing side, and a color reproduction system using the same.

2. Description of the Related Art

In the prior art, as a means to represent the color (brightness, hue and saturation) and spectral reflectance information of an image, a multispectral image having spectral sensitivity characteristics of not less than 3 bands per pixel of the image is used. The multispectral image is obtained by dividing the wavelength of a subject into a plurality of bands and estimating the spectral reflectance distribution per image based on a multiband image composed of a plurality of band images obtained by shooting the subject per band, and capable of representing the spectral reflectance information of the subject, which is impossible to be sufficiently represented in an existing RGB color image composed of red (R), green (G) and blue (B) images.

Therefore, even when the illumination environment on the observing side is different from that on the shooting side, it is possible to precisely reproduce the color of a subject under the illumination environment on the observing side from the estimated spectral reflectance information of the subject based on the multispectral image, which is very effective in telemedicine, web shopping and the like, for example, where precise color reproduction of a subject under different observing environment is desired.

However, although it is possible to precisely reproduce the color of a subject by effectively using a multispectral image when the multispectral image is received by a special output device such as a multi primary color monitor, the color of the subject cannot be precisely reproduced when the image is received with an existing RGB color image output device, wherein information for only 3 bands of the multispectral image can be processed.

As a method for encoding a multispectral image in consideration of compatibility with the existing 3-band system, it is known to separate the multispectral image into 3-band signals expanded by a color matching function standardized by CIE (Commission Internationale de l'Eclairage) and a residual principal components orthogonal thereto in spectral space to encode. (For example, see Patent Document 1: JP2004159045A and Non-patent Document 1: Keusen, “Multispectral color system with an encoding format compatible with the conventional tristimulus model”, J.IS&T, vol. 40, no. 6, pp. 510-515, November/December 1996)

According to the encoding method, in the existing RGB color image output device, by using 3-band signals expanded by a color matching function, it is possible to observe an image under a predetermined observing environmental condition (conditions of illumination and characteristics of the eyes of an observer), and also in the special device, by including and using a residual principal component, it is possible to effectively utilize multispectral information to precisely reproduce the color of a subject.

### SUMMARY OF THE INVENTION

The first aspect of the invention is a multispectral image processing device comprising:

a base image conversion unit for expanding an input multiband image of a subject based on base vectors to convert the input multiband image into a base image;
a base vector calculation unit for calculating the base vectors; and
an output unit for outputting a multispectral image based on the base image converted in the base image conversion unit, wherein
the base vector calculation unit calculates base vectors for 3 primary colors obtained by the product of a predetermined rendering illumination spectrum and a color matching function, and orthogonal base vectors which are orthogonal to the base vectors for the 3 primary colors and based on statistical information on the spectral reflectance of the subject as the base vectors.

Moreover, the second aspect of the invention is a color reproduction system having

a multispectral image processing device comprising: a base image conversion unit for expanding an input multiband image of a subject based on base vectors to convert the input multiband image into a base image; a base vector calculation unit for calculating the base vectors; and an output unit for outputting a multispectral image based on the base image converted in the base image conversion unit, wherein the base vector calculation unit calculates base vectors for 3 primary colors obtained by the product of a predetermined rendering illumination spectrum and a color matching function, and orthogonal base vectors which are orthogonal to the base vectors for the 3 primary colors and based on statistical information on the spectral reflectance of the subject as the base vectors, and
a multispectral color reproduction device for performing a color reproduction process based on the base vectors on a multispectral image output from the multispectral image processing device and displays the image on a monitor.

### BRIEF DESCRIPTION OF THE DRAWINGS

The present invention will be described with reference to the accompanying drawings wherein;

FIG. 1 is a functional block diagram showing the configuration of the main part of a multispectral image processing device according to an embodiment 1 of the present invention;

FIG. 2 is a functional block diagram showing the configuration of the base vector calculation unit shown in FIG. 1;

FIG. 3 is a functional block diagram showing the configuration of the transmission and recording unit shown in FIG. 1;

FIG. 4 is a functional block diagram showing the configuration of the main part of a color reproduction system according to an embodiment 2 of the present invention;

FIG. 5 is a functional block diagram showing the configuration of the main part of a reception and reproduction unit in a multispectral color reproduction device shown in FIG. 4;

FIG. 6 is a functional block diagram showing the configuration of the main part of a color reproduction system according to an embodiment 3 of the present invention;

FIG. 7 is a functional block diagram showing the configuration of the main part of a conversion base vector calculation unit in a multispectral image processing device shown in FIG. 6;

FIG. 8 is a functional block diagram showing the configuration of the main part of a restoration base vector calculation unit in a multispectral color reproduction device shown in FIG. 6;

FIG. 9 is a functional block diagram showing the configuration of the main part of a color reproduction system according to an embodiment 4 of the present invention;

FIG. 10 is a functional block diagram showing the configuration of the main part of a broadcasting station shown in FIG. 9;

FIG. 11 is a diagram illustrating the transmission of a base vector for restoration transmitted from a second channel in the embodiment 4;

FIG. 12 is a functional block diagram showing the configuration of the main part of an NV reception unit in a fixed reception unit shown in FIG. 9; and

FIG. 13 is a functional block diagram showing the configuration of the main part of a receiver (TV) used in a color reproduction system according to an embodiment 5 of the present invention.

### DETAILED DESCRIPTION OF THE PREFERRED EMBODIMENTS

Embodiments of the present invention will now be described with reference to the drawings.

### Embodiment 1

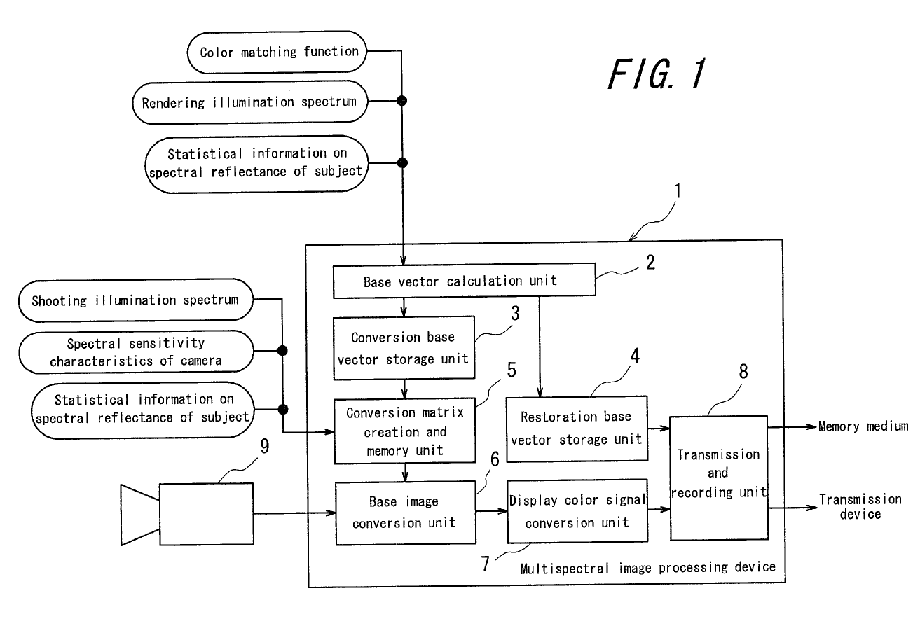

FIG. 1 is a functional block diagram showing the configuration of the main part of a multispectral image processing device according to an embodiment 1 of the present invention. A multispectral image processing device 1 of the present embodiment comprises a base vector calculation unit 2, a conversion base vector storage unit 3, a restoration base vector storage unit 4, a conversion matrix creation and memory unit 5, a base image conversion unit 6, display color signal conversion unit 7 and a transmission and recoding unit 8, and converts a multiband image from a multispectral camera 9 into a multispectral image for transmission and recording to output it to a transmission device not shown or a recording medium, for example.

The base vector calculation unit 2 calculates base vectors for conversion into an image of existing 3 primary colors by using a color matching function and a predetermined rendering illumination spectrum, calculates base vectors for conversion into an image of residual orthogonal components by using statistical information on the spectral reflectance of a subject, and outputs these calculated base vectors for conversion to the conversion base vector storage unit 3. Furthermore, the base vector calculation unit 2 calculates base vectors different from the aforementioned base vectors for conversion as base vectors for restoring the spectral reflectance of the subject from an image converted by the base vectors for conversion, and outputs the calculated base vectors for restoration to the base vector for restoration storage unit 4. The detail of the base vector calculation unit 2 will be described hereinafter.

The conversion base vector storage unit 3 stores base vectors for conversion calculated in the base vector calculation unit 2. The base vectors for conversion stored in the conversion base vector storage unit 3 are used in the subsequent conversion matrix creation and memory unit 5.

The base vector for restoration storage unit 4 stores base vectors for restoration calculated in the base vector calculation unit 2. The base vectors for restoration stored in the restoration base vector storage unit 4 are used in the subsequent transmission and recording unit 8.

The conversion matrix creation and memory unit 5 creates and memorizes a conversion matrix for converting a multiband image into a base image of existing 3 primary colors and a base image of a residual orthogonal component by using the base vector for conversion stored in the conversion base vector storage unit 3, a shooting illumination spectrum when a subject is shot by the multispectral camera 9, spectral sensitivity characteristics of the multispectral camera 9 and statistical information on the spectral reflectance of the subject. The concrete content of the conversion matrix created in the conversion matrix creation and memory unit 5 will be described hereinafter.

The base image conversion unit 6 converts a multiband image from the multispectral camera 9 into a base image of existing 3 primary colors and a base image of a residual orthogonal component by using a conversion matrix memorized in the conversion matrix creation and memory unit 5, and outputs it to the display color signal conversion unit 7.

The display color signal conversion unit 7 converts a base image converted in the base image conversion unit 6 into an image signal in display color space for displaying the image on a monitor and the like, obtains 3 primary color signals C1, C2 and C3, and residual orthogonal component signals C4, C5 and C6, and outputs these display color signals to the transmission and recording unit 8. Although the display color space for conversion can be sRGB and YCC defined as the general standard, it is desirable to be bg-sRGB, sYCC, xv-YCC and the like as extended color space with wide color gamut, considering that the image is to be restored again after multispectral image conversion, as in the present embodiment.

The transmission and recording unit 8 encodes display color signals converted in the display color signal conversion unit 7, and outputs them to a transmission device or a memory medium. The detail of the transmission and recording unit 8 will be described hereinafter.

The multispectral image processing device 1 of the present embodiment having the configuration described above calculates and memorizes base vectors and a conversion matrix in advance based on various characteristic information such as a color matching function, a rendering illumination spectrum, statistical information on the spectral reflectance of a subject, a shooting illumination spectrum and spectral sensitivity characteristics of a camera so as to rapidly create a multispectral image for transmission and recording from an input multiband image by using the memorized conversion matrix.

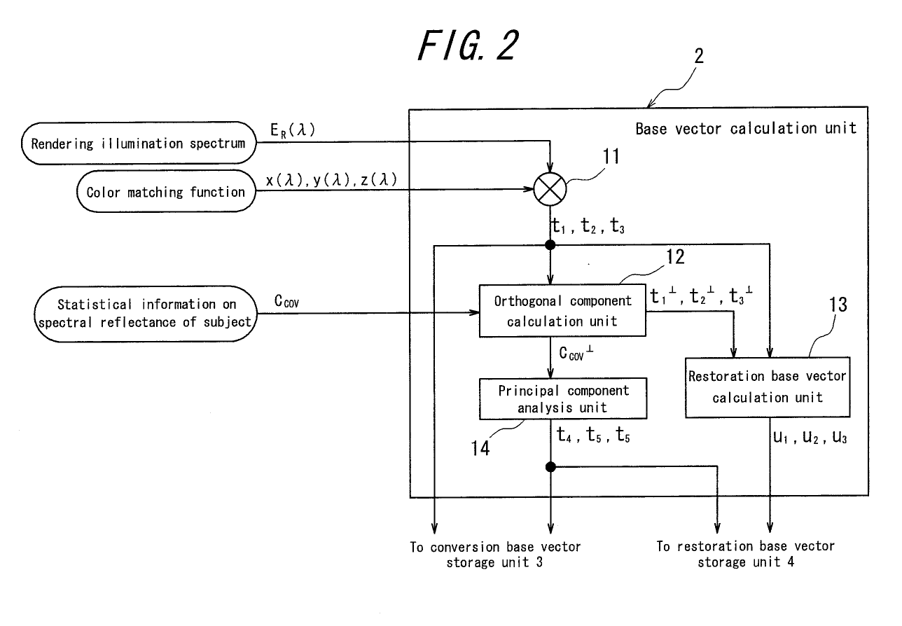

FIG. 2 is a functional block diagram showing the configuration of the base vector calculation unit 2 shown in FIG. 1. The base vector calculation unit 2 has a multiplication unit 11, an orthogonal component calculation unit 12, a restoration base vector calculation unit 13 and a principal component analysis unit 14. In the base vector calculation unit 2, first the multiplication unit 11 multiplies a predetermined rendering illumination spectrum E_{R}(λ) by each of color matching functions x(λ), y(λ) and z(λ) according to an expression (1) below to calculate T₁(λ) to T₃(λ).

T₁(λ)=E_{R}(λ)·x(λ)

T₂(λ)=E_{R}(λ)·y(λ)

T₃(λ)=E_{R}(λ)·z(λ) (1)

T₁(λ) to T₃(λ) obtained from the above expression (1) are expressed in N-dimensional vector notation as the first base vector t₁ to the third base vector t₃ as shown in an expression (2) below. T denotes transposition.

t₁=(T₁(λ₁), T₁(λ₂), . . . T₁(λ₁))^{T}

t₂=(T₂(λ₁), T₂(λ₂), . . . , T₂(λ_{N}))^{T}

t₃=(T₃(λ₁), T₃(λ₂), . . . , T₃(λ_{N}))^{T} (2)

The first base vector to the third base vector calculated as such are stored in the conversion base vector storage unit 3 and used in the orthogonal component calculation unit 12 and the restoration base vector calculation unit 13.

In the orthogonal component calculation unit 12, the first base vector to the third base vector calculated in the multiplication unit 11 are input, and statistical information is calculated from a component orthogonal to the first base vector to the third base vector according to statistical information on the spectral reflectance of a subject given in advance, and is output to the principal component analysis unit 14. Specifically, when a covariance matrix C_{COV} obtained from the spectral reflectance of some sample subjects are given in advance as the statistical information on the spectral reflectance of the subjects, orthogonalization is performed by a method shown below.

First, when a matrix for mapping in complementary space orthogonal to the first base vector to the third base vector is set as P, the matrix P can be obtained by an expression (3) below using well-known Gram-Schmidt orthogonalization.

P=P₃·P₂·P₁ (3)

P1, P2 and P3 can be recurrently obtained by expressions (4), (5) and (6) below.

$$\begin{matrix}{P}_{1} = I - \frac{{t}_{1}^{⊥} \cdot {t}_{1}^{⊥ T}}{{‖ {t}_{1}^{⊥} ‖}^{2}} \\ Note \text{:} {t}_{1}^{⊥} = {t}_{1} & ( 4 ) \\ {P}_{2} = I - \frac{{t}_{2}^{⊥} \cdot {t}_{2}^{⊥ T}}{{‖ {t}_{2}^{⊥} ‖}^{2}} \\ Note \text{:} {t}_{2}^{⊥} = {P}_{1} \cdot {t}_{2} & ( 5 ) \\ {P}_{3} = I - \frac{{t}_{3}^{⊥} \cdot {t}_{3}^{⊥ T}}{{‖ {t}_{3}^{⊥} ‖}^{2}} \\ Note \text{:} {t}_{3}^{⊥} = {P}_{2} \cdot {t}_{3} & ( 6 )\end{matrix}$$

As shown in an expression (7) below, by using the matrix P for mapping in orthogonal complementary space of the above expression (3), the covariance matrix C_{cov} of the spectral reflectance of a subject is converted into a covariance matrix C_{COV}^{⊥} of a component orthogonal to the first base vector to the third base vector and the converted covariance matrix C_{COV}^{⊥} is output to the principal component analysis unit 14 as orthogonalized statistical information.

C_{COV}^{⊥}=P·C_{COV}·^{T} (7)

Moreover, orthogonal base vectors t₁^{⊥}, t₂^{⊥} and t₃^{⊥} obtained by the above expressions (4) to (6) are output to the restoration base vector calculation unit 13.

Although the covariance matrix C_{COV} is obtained from the spectral reflectance of some samples subjects in the above description, when a basis function of the spectral reflectance as statistical information of the subject is given in advance, the covariance matrix C_{COV} may be created from the basis function.

In the restoration base vector calculation unit 13, the first base vector to the third base vector uₖ (k=1˜3) of the base vectors for restoration are calculated by an expression (8) below using the first base vector to the third base vector calculated as the base vectors for conversion in the multiplication unit 11 and the orthogonal base vectors t₁^{⊥}, t₃^{⊥} and t₃^{⊥} calculated in the orthogonal component calculation unit 12.

uₖ=tₖ^{⊥}·(T^{T}·U)⁻¹ (8)

Note:

T=[t₁t₂t₃], U=[t₁^{⊥}t₂^{⊥}t₃^{⊥}] (9)

Since the first base vector to the third base vector calculated as the base vectors for conversion are not orthogonal basis, in order to restore the spectral reflectance component of a subject from an expansion coefficient expanded thereby, the expansion coefficient needs to be mapped in orthogonal base space. Therefore, in the above expression (8), a mapping is expressed by a matrix (•)⁻¹ and thereby vectors for restoring the spectral reflectance components of the subject can be obtained from the expansion coefficients of the first base vector to the third base vector, which are not orthogonal basis.

uₖ (k=1˜3) obtained above is stored in the restoration base vector storage unit 4 as the first base vector to the third base vector of the base vectors for restoration.

In the principal component analysis unit 14, a base vector tₖ (k=4˜6) is calculated by using the orthogonal component of the covariance matrix C_{COV}^{⊥} calculated in the orthogonal component calculation unit 12 and by selecting 3 eigenvectors having a highest expansion contribution out of eigenvectors corresponding to eigenvalues by an expression (10) below.

C_{COV}^{⊥}·tₖ=λₖ·tₖ (10)

The fourth base vector to the sixth base vector calculated above, which are used both for conversion and restoration, are stored in both the conversion base vector storage unit 3 and the restoration base vector storage unit 4.

In addition, although 6 base vectors in total of 3 base vectors for 3 primary colors and 3 residual orthogonal base vectors are calculated here as the base vectors, if there is surplus capacity for transmission and recording, k in the above expression (8) can be extended to higher dimension to increase a number of the base vector not less than 6.

Next, the detail about the conversion matrix created in the conversion matrix creation and memory unit 6 shown in FIG. 1 will be described.

First, when a pixel value of a multiband image shot by the multispectral camera 9 is set as g, (i=1˜M, M is a number of shooting band), the pixel value g, can be expressed as an expression (11) below by using the spectral reflectance f(λ) of the shot subject, an illumination spectrum E_{O}(λ) at the time of shooting and spectral sensitivity characteristics Sᵢ(λ) of the camera.

gᵢ=∫Sᵢ(λ)·E_{O}(λ)·f(λ)·dλ (11)

Furthermore, when a basis function Oⱼ(λ) (j=1˜J, J is a number of basis) is given as statistical information on the spectral reflectance of a subject, the spectral reflectance f(λ) of the subject is expressed by an expression (12) below.

$$f ( λ ) = {\sum }_{j = 1}^{J} {a}_{j} \cdot {O}_{j} ( λ ) \qquad ( 12 )$$

Therefore, the aforementioned expression (11) can be expressed as an expression (13) below by using the above expression (12).

$${g}_{i} = {\sum }_{j = 1}^{J} {a}_{j} \int {S}_{i} ( λ ) \cdot {E}_{O} ( λ ) \cdot {O}_{j} ( λ ) \cdot d λ \qquad ( 13 )$$

Also, the above expression (13) in matrix notation is as an expression (14) below.

g=H·a (14)

A vector g is g=(g₁, g₂, g_{M})^{T}, and a vector a is a=(a₁, a₂, . . . , a_{J})^{T}. Moreover, a matrix H is expressed by an expression (15) below.

H={Hᵢⱼ}=∫Sᵢ(λ)·E_{O}(λ)·Oⱼ(λ)·dλ (15)

On the other hand, when the spectral reflectance f(λ) of a subject is given, it can be converted into a pixel value Iₖ (k=1˜6) of a base image by an expression (16) below using the first base vector to the sixth base vector stored in the conversion base vector storage unit 3 mentioned above.

Iₖ=∫f(λ)·tₖ(λ)·dλ (16)

In this expression, tₖ(λ) is a vector tₖ in functional notation. It should be noted that the above expression (16) can also be expressed as an expression (17) below by using the above expression (12).

$${I}_{k} = {\sum }_{j = 1}^{J} {a}_{j} \int {O}_{j} ( λ ) \cdot {t}_{k} ( λ ) \cdot d λ \qquad ( 17 )$$

Also, the above expression (17) in matrix notation is as an expression (18) below.

I=B·a (18)

Note:

B={Bₖⱼ}=∫Oⱼ(λ)·tₖ(λ)·dλ (19)

A matrix M for converting the pixel value gᵢ of the multiband image shot by the multispectral camera 9 into the pixel value Iₖ of the base image is derived as an expression (20) below by using the above expressions (14) and (18).

M=B·H* (20)

A matrix H* denotes a generalized inverse matrix of the matrix H. Therefore, when least square estimation is used as a method for calculating a generalized inverse matrix, the above expression (20) becomes as an expression (21) below.

M=B· [symbol] a·a^{T} [symbol] ·H^{T}·(H· [symbol] a·a^{T} [symbol] ·H^{T})⁻¹ (21)

Additionally, in the above expression (21), <aa^{T}> denoting an ensemble average of the vector a can be obtained from a statistic (contribution) to the basis function Oⱼ(λ) mentioned above.

As above, in the conversion matrix creation and memory unit 5, the matrix M for converting the pixel value g, of the multiband image shot by the multispectral camera 9 into the pixel value Iₖ of the base image is calculated and memorized based on the expressions (20) to (21).

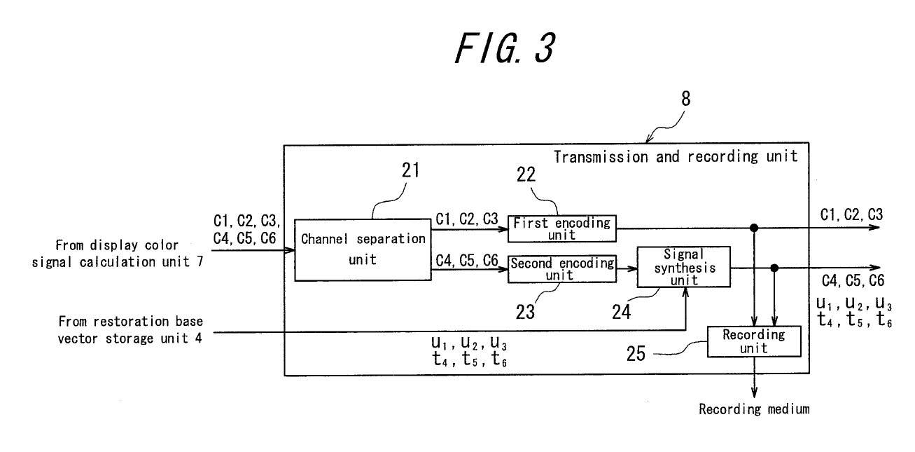

FIG. 3 is a functional block diagram showing the configuration of the transmission and recording unit 8 shown in FIG. 1. The transmission and recording unit 8 has a channel separation unit 21, a first encoding unit 22, a second encoding unit 23, a signal synthesis unit 24 and a recording unit 25.

The channel separation unit 21 receives display color signals C1, C2, . . . and C6 converted in the display color signal conversion unit 7 of the former paragraph, separates signals of existing 3 primary colors C1, C2 and C3 and residual orthogonal component signals C4, C5 and C6, and outputs the 3 primary color signals C1, C2 and C3 to the first encoding unit 22 and the orthogonal component signals C4, C5 and C6 to the second encoding unit 23, respectively.

The first encoding unit 22 encodes the 3 primary color signals C1, C2 and C3 separated in the channel separation unit 21 by using a predetermined encoding algorithm. Also, the second encoding unit 23 encodes the orthogonal component signals C4, C5 and C6 separated in the channel separation unit 21 by using a predetermined encoding algorithm. Moreover, encoding in the first encoding unit 22 and the second encoding unit 23 can be performed by using the same algorithm or parameter and also be performed by using the different algorithm or parameter.

The signal synthesis unit 24 synthesizes the encoded signals of the orthogonal component signals C4, C5 and C6 and the base vectors for restoration u₁, u₂, u₃, t₄, t₅ and t₆ input from the restoration base vector storage unit 4 separately from an image signal. Since information on the base vectors for restoration do not need to be synthesized each time per 1 frame of the image signal, the base vectors for restoration are synthesized only when the base vectors for restoration are updated, and other than that, only an address of a frame storing the base vectors for restoration may be added, for example.

The signals (C1, C2, C3) encoded in the first encoding unit 22 and the signals (C4, C5, C6, u₁, u₂, u₃, t₄, t₅, t₆) synthesized in the signal synthesis unit 24 are recorded with a recording medium in the recording unit 25 or output through individual pathways to be transmitted by a transmission device.

As such, by outputting the encoded 3 primary color signals (C1, C2, C3) and the synthesized signals (C4, C5, C6, u₁, u₂, u₃, t₄, t₅, t₆) of the encoded orthogonal component signals and the base vectors for restoration through individual pathways, it is possible to use an existing 3 primary color transmission system to transmit a multispectral image through a plurality of channels (2 channels) in parallel. Thereby, on the transmitted side (image observing side), by receiving only channels of C1, C2 and C3 out of the signals transmitted through a plurality of channels, it is possible to observe the image with the existing general-purpose 3 primary color device, and also by receiving the both 2 channels, with a special output device, it is possible to output a color image effectively utilizing the multispectral image such as conversion of illumination environment.

Also, an image is recorded in a recording medium in the recording unit 25, so that the encoded 3 primary color signals (C1, C2, C3) or all signals including the 3 primary color signals (C1, C2, C3) and the synthesized signals (C4, C5, C6, u₁, u₂, u₃, t₄, t₅, t₆) are selectively read out.

As above, according to the present embodiment, when a multispectral image is transmitted and recorded, by performing conversion processes separately between display 3 primary color signals and residual signals, it is possible to perform transmission and recording highly compatible with existing 3 primary color devices. Moreover, by using a rendering illumination spectrum and statistical information on the spectral reflectance of a subject to create the residual signals, it is possible to transmit and record a multispectral image signal, which has high restoration accuracy of the spectral reflectance of the subject and is most suitable for illumination conversion on the observing side. Although the rendering illumination spectrum and the shooting illumination spectrum are described as different in the above description, the rendering illumination spectrum and the shooting illumination spectrum may be the same.

### Embodiment 2

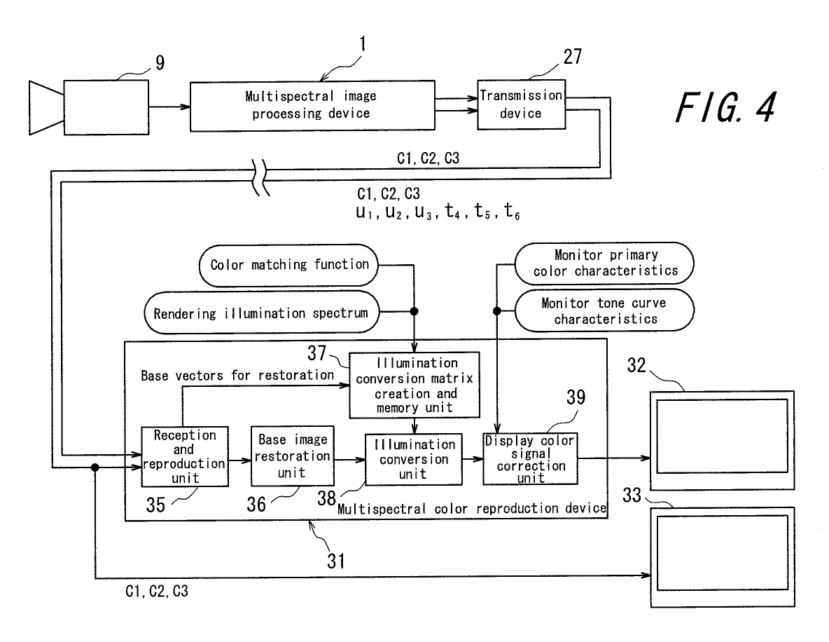

FIG. 4 is a functional block diagram showing the configuration of the main part of a color reproduction system according to an embodiment 2 of the present invention. The color reproduction system of the present embodiment comprises a transmission device 27, a multispectral color reproduction device 31, a multi primary color monitor 32 and a normal RGB monitor 33 as well as the multispectral camera 9 and the multispectral image processing device 1 described in the embodiment 1, and transmits a multispectral image taken by the multispectral camera 9 and processed in the multispectral image processing device 1 to the observing side through internet, radio transmission or the like by the transmission device 27, so as to display the image on the multi primary color monitor 32 by using the multispectral color reproduction device 31 on the observing side for illumination conversion or displays it on the normal RGB monitor 33 as an image under a predetermined observing environmental condition.

Although a multispectral image obtained from the multispectral image processing device 1 is transmitted to the observing side by the transmission device 27 in FIG. 4, the multispectral image obtained from the multispectral image processing device 1 may be recorded in a recording medium to be provided to the observing side as described in the embodiment 1.

The multispectral color reproduction device 31 will be described below. The multispectral color reproduction device 31 has a reception and reproduction unit 35, a base image restoration unit 36, an illumination conversion matrix creation and memory unit 37, an illumination conversion unit 38 and a display color signal correction unit 39.

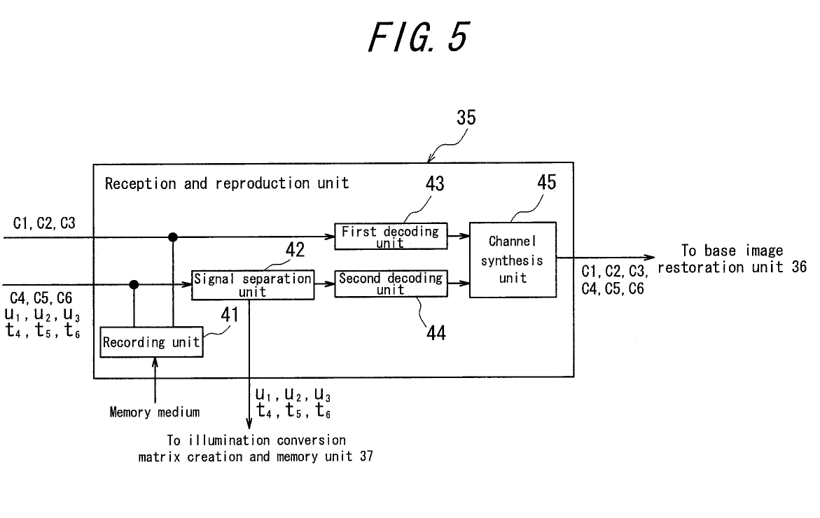

The reception and reproduction unit 35 has a reproduction unit 41, a signal separation unit 42, a first decoding unit 43, a second decoding unit 44 and a channel synthesis unit 45 as shown in FIG. 5. The reproduction unit 41 reproduces the 3 primary color signals C1, C2 and C3 and the orthogonal component signals C4, C5 and C6 recorded in a recording medium respectively in synchronization with each other. The orthogonal component signals C4, C5 and C6 are also synthesized with the base vectors for restoration u₁, u₂, u₃, t₄, t₅ and t₆ and reproduced.

The signal separation unit 42 separates the synthesized signals of the orthogonal component signals C4, C5 and C6 and the base vectors for restoration u₁, u₂, u₃, t₄, t₅, and t₆, which are transmitted by the transmission device 27 or reproduced by the reproduction unit 41, into the orthogonal component signals and the base vectors for restoration, and outputs the orthogonal component signals C4, C5 and C6 to the second decoding unit 44 and the base vectors for restoration u₁, u₂, u₃, t₄, t₅, and t₆ to the illumination conversion matrix creation and memory unit 37, respectively.

The first decoding unit 43 decodes the 3 primary color signals C1, C2 and C3, which are transmitted by the transmission device 27 or reproduced by the reproduction unit 41, back to the display color 3 primary color signals. Here, the decoding process is performed by an inverse conversion of the encoding process performed in the first encoding unit 22 of the transmission and recording unit 8 in the multispectral image processing device 1 shown in FIG. 3.

Similarly, the second decoding unit 44 performs the decoding process by an inverse conversion of the encoding process performed in the second encoding unit 23 of the transmission and recording unit 8 shown in FIG. 3 on the orthogonal component signals C4, C5 and C6, which are transmitted by the transmission device 27 or input from the reproduction unit 41 through the signal separation unit 42, generates the display color signals and outputs them.

The channel synthesis unit 45 synthesizes the display color signals of C1, C2 and C3 and C4, C5 and C6, which are decoded respectively by the first decoding unit 43 and the second decoding unit 44 and input separately, so as to outputs them to the base image restoration unit 36 of the subsequent paragraph.

In FIG. 4, the base image restoration unit 36 restores the display color signals input from the reception and reproduction unit 35 to the base image signals. Here, an inverse conversion process of the conversion process performed in the display color signal conversion unit 7 shown in FIG. 1 is performed.

The illumination conversion matrix creation and memory unit 37 inputs the base vectors for restoration separated in the signal separation unit 42 of the reception and reproduction unit 35, and based on an observing illumination spectrum and a color matching function further input externally, creates and memorizes an illumination conversion matrix Q for converting the illumination environment of an image from the rendering illumination assumed in the 3 primary color signals to the observing illumination. The illumination matrix Q (3×6 matrix) is created by an expression (22) below, in concrete terms.

$${Q}_{3 \times 6} = \\ [ \begin{matrix}\begin{matrix}\int {E}_{O} ( λ ) \cdot x ( λ ) \cdot \\ {U}_{1} ( λ ) d λ\end{matrix} & … & \begin{matrix}\int {E}_{O} ( λ ) \cdot x ( λ ) \cdot \\ {U}_{3} ( λ ) d λ\end{matrix} & \begin{matrix}\int {E}_{O} ( λ ) \cdot x ( λ ) \cdot \\ {T}_{4} ( λ ) d λ\end{matrix} & … & \begin{matrix}\int {E}_{O} ( λ ) \cdot x ( λ ) \cdot \\ {T}_{6} ( λ ) d λ\end{matrix} \\ \begin{matrix}\int {E}_{O} ( λ ) \cdot y ( λ ) \cdot \\ {U}_{1} ( λ ) d λ\end{matrix} & … & \begin{matrix}\int {E}_{O} ( λ ) \cdot y ( λ ) \cdot \\ {U}_{3} ( λ ) d λ\end{matrix} & \begin{matrix}\int {E}_{O} ( λ ) \cdot y ( λ ) \cdot \\ {T}_{4} ( λ ) d λ\end{matrix} & … & \begin{matrix}\int {E}_{O} ( λ ) \cdot y ( λ ) \cdot \\ {T}_{6} ( λ ) d λ\end{matrix} \\ \begin{matrix}\int {E}_{O} ( λ ) \cdot z ( λ ) \cdot \\ {U}_{1} ( λ ) d λ\end{matrix} & … & \begin{matrix}\int {E}_{O} ( λ ) \cdot z ( λ ) \cdot \\ {U}_{3} ( λ ) d λ\end{matrix} & \begin{matrix}\int {E}_{O} ( λ ) \cdot z ( λ ) \cdot \\ {T}_{4} ( λ ) d λ\end{matrix} & … & \begin{matrix}\int {E}_{O} ( λ ) \cdot z ( λ ) \cdot \\ {T}_{6} ( λ ) d λ\end{matrix}\end{matrix} ] \qquad ( 22 )$$

E_{O}(λ) and x(λ), y(λ) and z(λ) denote the observing illustration spectrum and color matching functions, and U₁(λ) to U₃(λ) and T₄(λ) to T₆(λ) are the base vectors for restoration u₁ to u₃ and t₄ to t₆ in functional notation.

The illumination conversion unit 38 performs matrix conversion of a base image input from the base image restoration unit 38 into an XYZ image under the observing illumination spectrum environment by using the illumination conversion matrix Q memorized in the illumination conversion matrix creation and memory unit 37.

The display color signal correction unit 39 converts the XYZ image under the observing illumination spectrum environment converted in the illumination conversion unit 38 into a display color signal by a well-known method based on primary color characteristics of the multi primary color monitor 32 and tone curve characteristics (y characteristics) of the multi primary color monitor 32, and outputs it to the multi primary color monitor 32. Specifically, R′, G′ and B′ are output by an expression (23) below applying the expressions (9) and (11) disclosed in Japanese Patent Application Laid-open No. 11-85952 for example. In the expression (23), Ox, Oy and Oz denote XYZ values under a monitor-offset light, and Lx, Ly and Lz denote XYZ values under an ambient light.

$$Matrix conversion ( \begin{matrix}{R}^{′} \\ {G}^{′} \\ {B}^{′}\end{matrix} ) = {( \begin{matrix}Xr max & Xg max & Xb max \\ Yr max & Yg max & Yb max \\ Zr max & Zg max & Zb max\end{matrix} )}^{- 1} ( \begin{matrix}X - {X}_{0} \\ Y - {Y}_{0} \\ Z - {Z}_{0}\end{matrix} ) \\ γ correction \\ \begin{matrix}R = γ {r}^{- 1} [ {R}^{′} ] \\ G = γ {g}^{- 1} [ {G}^{′} ] \\ B = γ {b}^{- 1} [ {B}^{′} ]\end{matrix} \\ Bias value \\ \begin{matrix}{X}_{0} = Ox + Lx \\ {Y}_{0} = Oy + Ly \\ {Z}_{0} = Oz + Lz\end{matrix} \qquad ( 23 )$$

According to the present embodiment, it is possible to receive a multispectral image for transmission and recording processed by the multispectral image processing device 1 in the embodiment 1 mentioned above with the multispectral color reproduction device 31 and display it on the multi primary color monitor 32 with high-accuracy color reproduction under an arbitrary observing illumination environment. Also, as shown in FIG. 4, it is possible to use 3 bands (C1, C2, C3) of the multispectral image for transmission and recording processed by the multispectral image processing device 1 as they are to display it on the normal RGB monitor 33 under a predetermined observing illumination environment.

### Embodiment 3

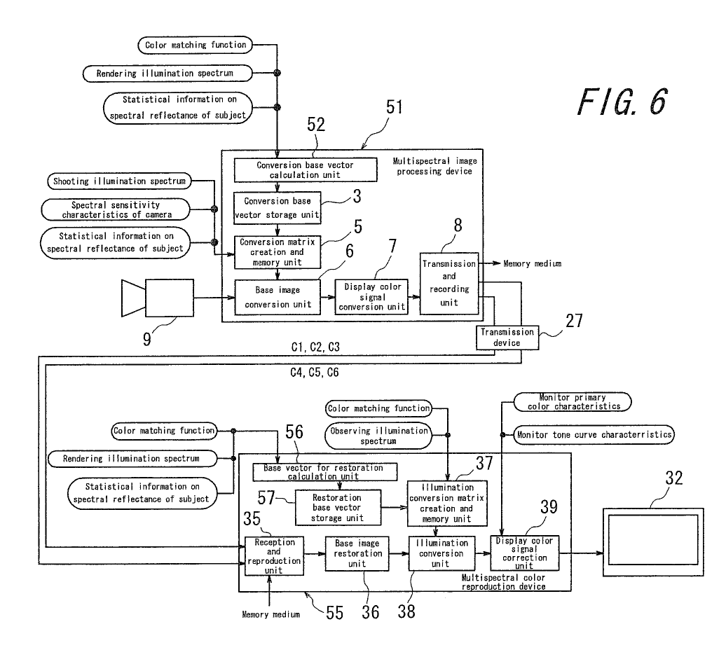

FIG. 6 is a functional block diagram showing the configuration of the main part of a color reproduction system according to an embodiment 3 of the present invention. The color reproduction system of the present embodiment omits the addition of the base vectors for restoration to an image signals during its transmission and transmits and records only the image signals of C1 to C6, by using normally-determined or disclosed information to create a rendering illumination spectrum, a color matching function and statistical information on the spectral reflectance of a subject, when a multispectral image for transmission and recording is created, in the color reproduction system of the embodiment 2.

Therefore, a multispectral image processing device 51 is, in the configuration shown in FIG. 1, adapted to provide a conversion base vector calculation unit 52 as a substitute for the base vector calculation unit 2, and omits the restoration base vector storage unit 4, and thereby calculates and stores only the base vectors for conversion as the base vectors. The other configuration is the same as the multispectral image processing device 1 shown in FIG. 1.

Moreover, a multispectral color reproduction device 55 is, in the configuration shown in FIG. 4, adapted to further add a restoration base vector calculation unit 56 and a restoration base vector storage unit 57 and calculate and store base vectors for restoration based on a rendering illumination spectrum, a matching color function and statistical information on the spectral reflectance of a subject. Other configuration is the same as the multispectral color reproduction device 31 shown in FIG. 4.

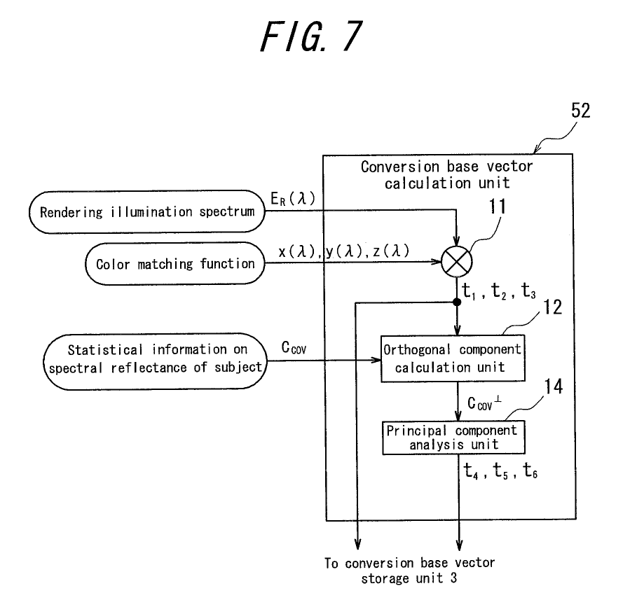

FIG. 7 is a functional block diagram showing the configuration of the main part of the conversion base vector calculation unit 52 in the multispectral image processing device 51 shown in FIG. 6. The conversion base vector calculation unit 52 is, in the configuration of the base vector calculation unit 2 shown in FIG. 2, adapted to omit the restoration base vector calculation unit 13, and calculate the vectors t₁ to t₆ as the base vectors for conversion by the expressions (2) and (10) mentioned above and store them in the conversion base vector storage unit 3.

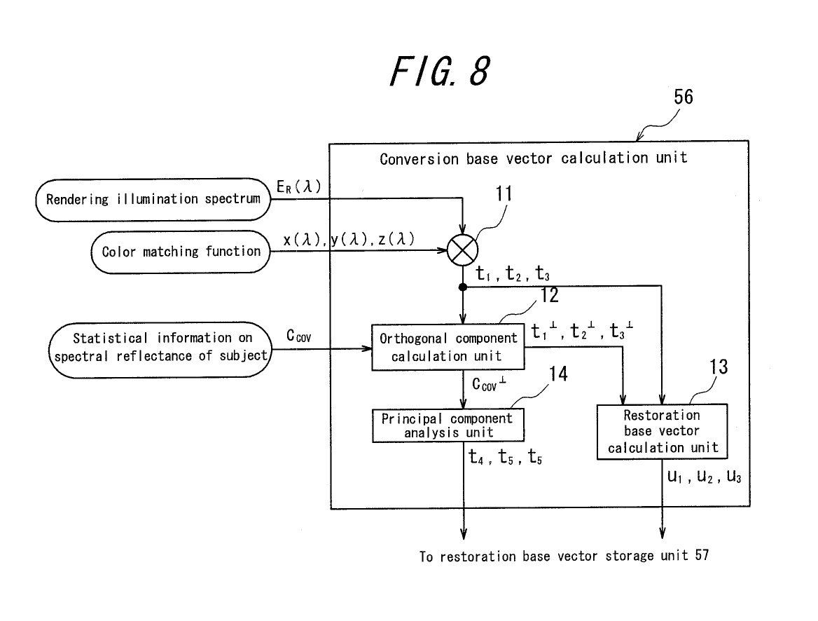

FIG. 8 is a functional block diagram showing the configuration of the main part of the restoration base vector calculation unit 56 in the multispectral color reproduction device 55 shown in FIG. 6. The restoration base vector calculation unit 56 is, in the configuration of the base vector calculation unit 2 shown in FIG. 2, adapted to omit the component for calculating a base vector for conversion, and calculate u₁ to u₃ and t₄ to t₆ as base vectors for restoration by the expressions (8) and (10) mentioned above to store them in the restoration base vector storage unit 57. In the base vectors for restoration calculated here, as compared to the base vectors for conversion, the former 3 base vectors are different and the latter 3 base vectors t₄ to t₆ are the same.

According to the present embodiment, it is possible to use normally-determined or disclosed information to create a rendering illumination spectrum, a color matching function and statistical information on the spectral reflectance of a subject of a multispectral image for transmission and recording, and transmit and record only an image signal to distribute and utilize the multispectral image. Therefore, since the base vectors for restoration do not need to be added to the image signal, it is possible to build a general-purpose color reproduction system using a conventional transmission device or transmission format. In addition, the rendering illumination spectrum, the color matching function and the statistical information on the spectral reflectance of the subject defined here may be memorized in the multispectral image processing device 51 and the multispectral color reproduction device 55 in advance, or may be recorded in an external server so that it can be used when needed.

### Embodiment 4

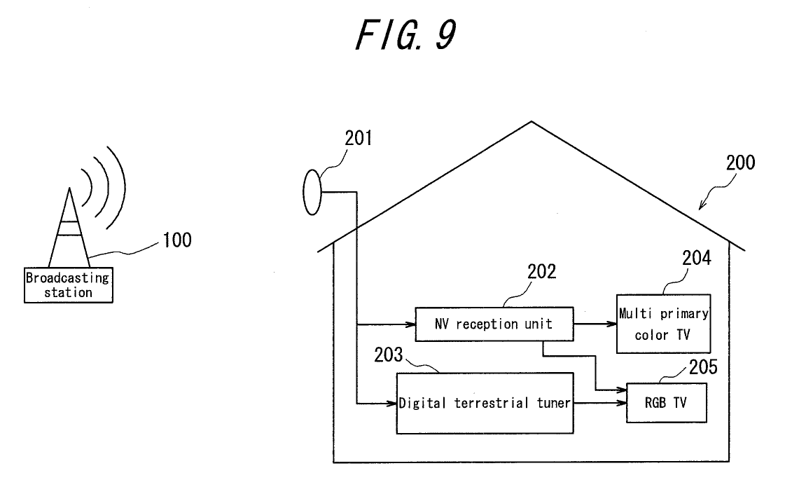

FIG. 9 is a functional block diagram showing the configuration of the main part of a color reproduction system according to an embodiment 4 of the present invention. The color reproduction system of the present embodiment is, for example, to broadcast the multispectral image generated in the multispectral image processing device 1 described in the embodiment 1 from a broadcasting station 100 through digital terrestrial TV waves for example, and to receive the airwaves with a fixed reception unit 200 to reproduce. Here, an image shot in 6 bands (colors) is broadcast as a multispectral image.

Since a multispectral image shot in 6 bands cannot be broadcast by one broadcast channel (physical channel) in the current digital terrestrial TV broadcasting wherein a band is too narrow to transmit, two physical channels are used here so as to broadcast the 3 primary color signals of the existing RGB C1, C2 and C3 by the one physical channel (first channel) and to broadcast the synthesized signals of the orthogonal component signals C4, C5 and C6 and the base vectors for restoration u₁, u₂, u₃, t₄, t₅ and t₆ by the other physical channel (second channel).

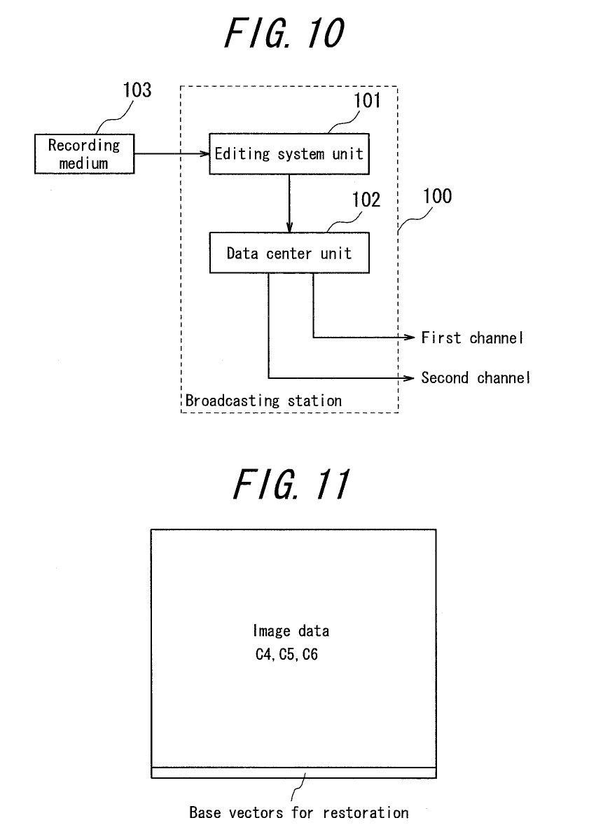

The broadcasting station 100 has an editing system unit 101 and a data center unit 102 as shown in the functional block diagram of the main part in FIG. 10. In the present embodiment, the multispectral image generated in the multispectral image processing device 1 described in the embodiment 1 is recorded in a recording medium 103, and content including the multispectral image recorded in the recording medium 103 is read out and edited in the editing system unit 101. Subsequently, the edited content is separated into the 3 primary color signals of RGB, C1, C2 and C3 for the first channel and the synthesized signals of the residual orthogonal component signals C4, C5 and C6 and the base vectors for restoration u₁, u₂, u₃, t₄, t₅ and t₆ for the second channel.

The signals separated for each channel in the data center unit 102, are amplified to RF signals for each channel in the corresponding transmission unit, and thereafter emitted from an individual or shared transmission antenna, which is not shown in the figures. The data of the base vectors for restoration transmitted from the second channel is, as shown in FIG. 11 for example, written in the bottom line of an image data of the orthogonal component signals C4, C5 and C6 or written by digital watermark in the image data for transmission.

On the other hand in FIG. 9, the fixed reception unit 200 has a reception antenna 201, a natural vision (NV) reception unit 202, a digital terrestrial tuner 203, a multi primary color receiver (TV) 204 and an RGB receiver (TV) 205.

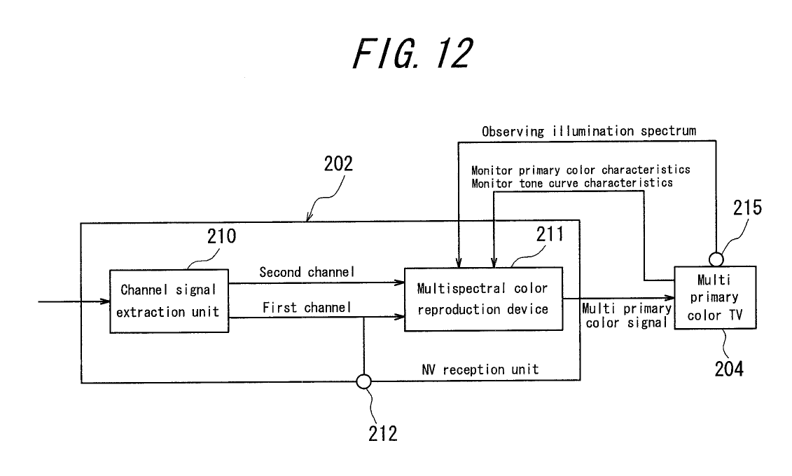

In the NV reception unit 202, a channel signal extraction unit 210, a multispectral color reproduction device 211 and an RGB output terminal 212 are provided as shown in FIG. 12. Also, in the multi primary color TV 204, a memory unit (not shown) for monitor primary color characteristics and monitor tone curve characteristics (γ characteristics) and an illumination spectrum detection sensor 215 are provided to supply the monitor primary color characteristics and the monitor γ characteristics memorized in the memory unit and an observing illumination spectrum detected by the illumination spectrum detection sensor 215 to the multispectral color reproduction device 211.

In the fixed reception unit 200, the RF signal received by the reception antenna 201 is supplied to the NV reception unit 202 and the digital terrestrial tuner 203. The NV reception unit 202 extracts signals for the first channel and the second channel from the signal received by the reception antenna 201 in the channel signal extraction unit 210, supplies these extracted signals for the first channel and the second channel to the multispectral color reproduction device 211, and outputs the signal for the first channel to the RGB output terminal 212.

The multispectral color reproduction device 211, which is configured similar to the multispectral color reproduction device 31 shown in the embodiment 2, displays the received multispectral image on the multi primary color TV 204 by an illumination conversion based on a color matching function, an observing illumination spectrum, monitor primary color characteristics and monitor y characteristics. Also, the RGB TV 205 is selectively connected to the RGB output terminal 212 of the NV reception unit 202 to display an image under a predetermined observing environmental condition by the 3 primary color signals C1, C2 and C3 received in the first channel.

On the other hand, the digital terrestrial tuner 203 tunes a desired channel, except for the second channel of transmitting the orthogonal component signal and the base vectors for restoration of the multispectral image mentioned above, from the signal received by the reception antenna 201 according to channel selection operation by a user and the like, and displays the signal of the tuned channel as an image on the normal RGB TV 205 under a predetermined observing environmental condition.

According to the present embodiment, by connecting the multi primary color TV 204 to the NV reception unit 202 having the multispectral color reproduction device 211 built-in, it is possible to view content including a multispectral image broadcast through two channels of the first channel and the second channel with high-accuracy color reproduction under an arbitrary observing illumination environment. Moreover, by connecting the normal RGB TV 205 to the RGB output terminal 212 of the NV reception unit 202 or connecting the normal RGB TV 205 to the digital terrestrial tuner 203, it is possible to display and view content including a multispectral image or content not including a multispectral image under a predetermined observing environmental condition.

### Embodiment 5

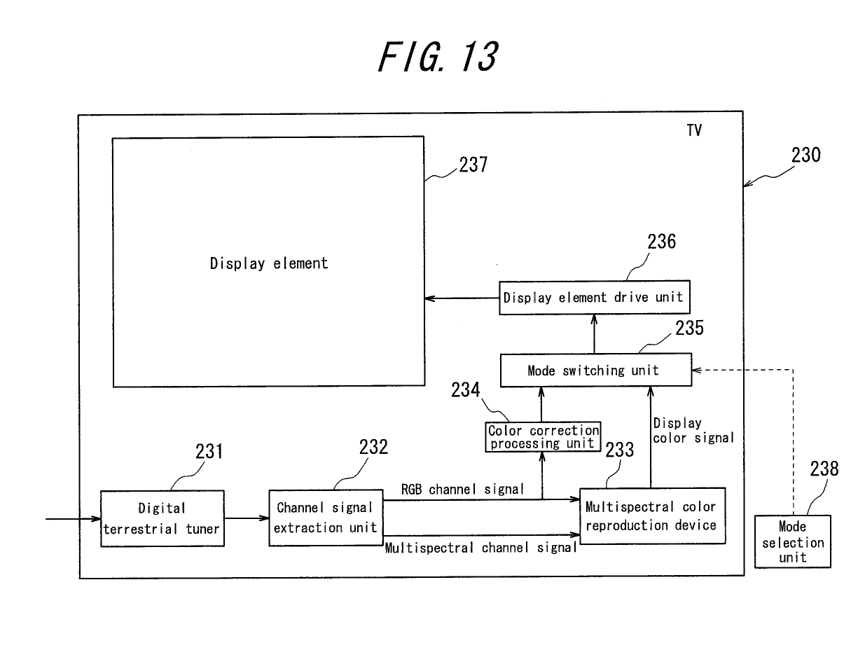

FIG. 13 is a functional block diagram showing the configuration of the main part of a receiver (TV) used in a color reproduction system according to an embodiment 5 of the present invention. The TV 230 is, in the rough outline, that of the embodiment 4 having the NV reception unit 202 and the digital terrestrial tuner 203 built-in.

Namely, the receiver (TV) 230 shown in FIG. 13 has a digital terrestrial tuner 231, a channel signal extraction unit 232, a multispectral color reproduction device 233, a color correction processing unit 234, a mode switching unit 235, a display element drive unit 236 and a display element 237 capable of displaying multi primary colors. In the present embodiment, when content including a multispectral image is transmitted by using two broadcast channels on the broadcasting station side, in each of the two channels, information indicating the counterpart channel is added for transmission, for example.

As such, in the digital terrestrial tuner 231, according to channel selection operation by a user and the like, when a channel broadcasts content including a multispectral image, two channels of the subject channel and the counterpart channel are tuned to supply signals of each channel to the channel signal extraction unit 232, and when a channel broadcasts content not including a multispectral image, only the subject channel is tuned to supply a signal of the tuned channel to the channel signal extraction unit 232.

When content includes a multispectral image, the channel signal extraction unit 232 supplies 3 primary color signals received by the one channel as RGB channel signals and residual orthogonal component signals and a base vectors for restoration received by the other channel as multispectral channel signals separately to the multispectral color reproduction device 233, and supplies the RBG channel signals to the color correction processing unit 234. Also, when content does not include a multispectral image, signals of the subject channel is supplied to the multispectral color reproduction device 233 and the color correction processing unit 234 as the RGB channel signals.

The multispectral color reproduction device 233, which is configured similar to the multispectral color reproduction device 31 of the embodiment 2, performs illumination conversion of the multispectral image received as the RGB channel signals and the multispectral channel signals based on a color matching function, an observing illumination spectrum, and primary color characteristics and y characteristics of the display element 237 to generate display color signals, and supplies the display color signals to the mode switching unit 235.

The color correction processing unit 234 corrects the RGB channel signal from the channel signal extraction unit 232 according to RGB primary color characteristics and y characteristics of the display element 237, and supplies them as display color signals to the mode switching unit 235.

The mode switching unit 235 selects the display color signals from the multispectral color reproduction device 233 or the display color signal from the color correction processing unit 234 according to mode selection operation by a user from a mode selection unit 238 provided in the TV 230 or a remote controller for example. Thereby, the TV 203 supplies the display color signals selected in the mode switching unit 235 through the display element drive unit 236 to the display element 237 to display.

According to the present embodiment, when content includes a multispectral image, by selecting the display color signals from the multispectral color reproduction device 233 in the mode switching unit 235, it is possible to display the multispectral image with high-accuracy color reproduction on the display element 237 under an arbitrary observing illumination environment to view the content, similar to the case of the embodiment 4. Also when content does not include a multispectral image, by selecting the display color signals from the color correction processing unit 234 in the mode switching unit 235, it is possible to display the image under a predetermined observing environmental condition suitable for the display element 237 to view the content.

Moreover, even when content includes a multispectral image, by selecting the display color signal from the color correction processing unit 234 in the mode switching unit 235, or even when content does not include a multispectral image, by selecting the display color signal from the multispectral color reproduction device 233, it is possible to display the image on the display element 237 under a predetermined observing environmental condition to view the content.

The present invention is not strictly limited to the above embodiments, and various changes and modifications can be made to the embodiments. For example, the embodiments 4 and 5 can be effectively applied to the case of broadcasting content through CATV (Community Antenna Television), and to the case in which image signals of only C1 to C6 are transmitted without the transmission of base vectors for restoration by using normally-determined or disclosed information to create a rendering illumination spectrum, a color matching function and statistical information on the spectral reflectance of a subject as the embodiment 3.

What is claimed is:

1. A multispectral image processing device comprising:
a base image conversion unit for expanding an input multiband image of a subject based on base vectors to convert the input multiband image into a base image;
a base vector calculation unit for calculating the base vectors; and
an output unit for outputting a multispectral image based on the base image converted in the base image conversion unit, wherein
the base vector calculation unit calculates base vectors for 3 primary colors obtained by the product of a predetermined rendering illumination spectrum and a color matching function, and orthogonal base vectors which are orthogonal to the base vectors for the 3 primary colors and based on statistical information on the spectral reflectance of the subject as the base vectors.

2. The multispectral image processing device according to claim 1, wherein
the base image conversion unit has a conversion matrix creation and memory unit, which creates and memorizes a conversion matrix for converting the multiband image into the base image based on the base vectors calculated in the base vector calculation unit.

3. The multispectral image processing device according to claim 1, wherein
the base vector calculation unit has restoration base vector calculation unit which calculates base vectors for restoration based on the base vectors for 3 primary colors and the base vectors formed by orthogonalizing the base vectors for 3 primary colors, and the output unit outputs the multispectral image with addition of the base vectors for restoration and the orthogonal base vectors.

4. The multispectral image processing device according to claim 2, wherein
the base vector calculation unit has a restoration base vector calculation unit, which calculates base vectors for restoration based on the base vectors for 3 primary colors and the base vectors formed by orthogonalizing the base vectors for 3 primary colors, and the output unit outputs the multispectral image with addition of the base vectors for restoration and the orthogonal base vectors.

5. A color reproduction system having
a multispectral image processing device comprising: a base image conversion unit for expanding an input multiband image of a subject based on base vectors to convert the input multiband image into a base image; a base vector calculation unit for calculating the base vectors; and an output unit for outputting a multispectral image based on the base image converted in the base image conversion unit, wherein the base vector calculation unit calculates base vectors for 3 primary colors obtained by the product of a predetermined rendering illumination spectrum and a color matching function, and orthogonal base vectors, which are orthogonal to the base vectors for the 3 primary colors and based on statistical information on the spectral reflectance of the subject as the base vectors, and
a multispectral color reproduction device for performing color reproduction process based on the base vectors on the multispectral image output from the multispectral image processing device and displays the image on a monitor.

6. The color reproduction system according to claim 5, wherein
the base image conversion unit has a conversion matrix creation and memory unit, which creates and memorizes a conversion matrix for converting the multiband image into the base image based on the base vectors calculated in the base vector calculation unit.

7. The color reproduction system according to claim 5, wherein
the base vector calculation unit has a restoration base vector calculation unit, which calculates base vectors for restoration based on the base vectors for 3 primary colors and the base vectors formed by orthogonalizing the base vectors for 3 primary colors, and the output unit outputs the multispectral image with addition of the base vectors for restoration and the orthogonal base vectors.

8. The color reproduction system according to claim 6, wherein
the base vector calculation unit has a restoration base vector calculation unit, which calculates base vectors for restoration based on the base vectors for 3 primary colors and the base vectors formed by orthogonalizing the base vectors for 3 primary colors, and the output unit outputs the multispectral image with addition of the base vectors for restoration and the orthogonal base vectors.
